(19) United States
(12) Patent Application Publication
(10) Pub. No.: US 2014/0317291 A1
(43) Pub. Date: Oct. 23, 2014

(54) SYSTEM AND METHOD FOR INTEGRATING TWO APPLICATION SERVER CONTAINERS IN A TELECOMMUNICATION NETWORK

(71) Applicants: SUBHASH VERMA, Fremont, CA (US); RAO NASIR KHAN, Kitchener (CA); RAJEEV ARYA, Noida (IN); VISHAL SHARMA, Noida (IN)

(72) Inventors: SUBHASH VERMA, Fremont, CA (US); RAO NASIR KHAN, Kitchener (CA); RAJEEV ARYA, Noida (IN); VISHAL SHARMA, Noida (IN)

(21) Appl. No.: 13/864,293

(22) Filed: Apr. 17, 2013

(51) Int. Cl. H04L 29/08

(52) U.S. Cl. CPC H04L 67/1002
USPC 709/226

(57) ABSTRACT

A system for integrating a first application server container with a second application server container in a telecommunication network. The system comprising a bidirectional messaging bus having a first end and a second end, a first messaging adapter conforming to the first application server container, the first messaging adapter communicably connected to the first end of the messaging bus and is deployed in the first application server container and a second messaging adapter conforming to the second application server container, the second messaging adapter communicably connected to the second end of the messaging bus and is deployed in the second application server container.

### CROSS-REFERENCE TO RELATED APPLICATIONS

This application claims the benefit of U.S. Provisional Application Ser. No. 61/635,096, filed on Apr. 18, 2012, the entire content of which is hereby incorporated by reference.

### FIELD OF THE INVENTION

The present invention relates generally to telecom application deployment requiring interworking of different programming models used in multiple application server containers and more particularly to a system and method for integrating two application server containers.

### BACKGROUND OF THE INVENTION

Application servers, typically operate on top of a wide range of existing enterprise systems such as database management systems, transaction monitors, and naming and directory services. Many of these application servers are built based on standard specifications such as the Java Platform, Enterprise Edition (JEE) to provide portability and scalability to applications managing and accessing various enterprise systems.

Exclusively in relation to application servers, there is currently a large number of commercial developments implementing the different versions of the Sipservlet and/or JEE standard etc.. The application servers act as containers of different pieces of software developed in the form of SipServlet, WEB and EJB applications, etc., adding support for external access to the server by means of protocols like HTTP, SOAP, RMI, JMS, etc. Basically, these application servers provide an interface for accessing the system through TCP-IP-based protocols.

Different applications server containers are integrated with other to combinely form and support one big high level application. The connection between two containers mainly includes ‘integration logic’ and ‘business logic’. The ‘integration logic’ includes the rules deciding what information from one container is sent and what information is needed at the other container. The ‘business logic’ is deciding what to do with the information received from the other container.

For example as shown in FIG. 1, a first container may send information in the form of three parameters p1, p3, p5 to second container. The second container receives this information and processes the parameters as per its business logic and the result may be sent back to the first container. It may be possible that the second container's business logic requires to process the parameters p1, p3, p5 and then need other parameters say p2, p4 etc. In such case the second server processes the parameters p1, p3, p5 and the again requests first container to send the required parameters p2, p4. After receiving the additional parameters the second container processes the information using its business logic to produce the desired result. In such scenario the first container may also send all the parameters p1, p2, p3, p4, p5 at once to the second container and the second container uses the parameters as per the needs of its business logic.

In complex telecom application deployment which requires interworking of various kinds of programming models used in multiple application server containers, any change in one of the containers requires changes in other container also to have compatible integration. The integration solution consists of applications that are provided by different vendors. These applications run on a variety of platforms. Some of these applications generate messages and many other applications consume the messages. If one the server container is being updated, then all the containers configuration connected to it have to be changed. Similarly in another case if one of the containers is being replaced with another container then this affects all connected containers and needs changes. Adding an application server container or removing an application server container entails balancing the communication between applications which usually creates dependencies between the applications. The sender application must communicate with the receiver applications. The receiver must recognize the messages from all the senders. These dependencies translate into coupling between the participants.

Usually, the applications have different interfaces and changing the interfaces of proprietary applications is difficult. Even if the interface of one application is changed, it is not feasible to change the interface for all the applications in the network.

Solving this problem include changing the programming model on one or many of the containers being integrated or merging the applications from multiple containers on to one container. Sometimes applications are modified to expose standards based interfaces to allow for more portable integration. However all of these mechanisms may require significant changes in applications, are not very scalable as the number of applications being integrated go up and result in tight dependencies on third party vendors providing the external applications.

Existing solutions require alteration of programming models running in various application containers to combine or merge these in complex deployments. This requires good amount of changes in one or more applications and makes the solution tied down to various third party vendors. Due to the extent of changes requires in terms of programming model changes, it becomes difficult to scale as the number of external applications increase.

In order to solve this issue, many interfaces have been standardized, e.g. Parlay. However not all external application containers/applications expose standards based interfaces for integration with other applications. Proprietary remote invocation mechanisms require significant alteration in programming models to be integrated across different application containers.

The various containers, though perhaps written to standard specifications, still vary in their functionality and approach. This poses a problem of changing the solution to use any other vendor solution because of the tight coupling. This problem is more pronounced with legacy applications that must be integrated into complex solutions.

In view of the limitations inherent in the systems and method of integrating application server containers, there exists a need for an improved systems and method of integrating application server containers in a complex telecom application deployment. The present invention solves the problem of interworking between various application server components in a complex telecom deployment scenario in an efficient and scalable fashion. It provides a framework to use various third party vendors without getting locked into a specific third party product in a fast, robust, and flexible manner. The present invention fulfills this need and provides further advantages as described in the following summary.

### SUMMARY OF THE INVENTION

In view of the foregoing disadvantages inherent in the prior arts, the general purpose of the present invention is to provide an improved combination of convenience and utility, to include the advantages of the prior art, and to overcome the drawbacks inherent therein.

A primary objective of the present invention is to provide a system and method for integrating a first application server container with a second application server container in a telecommunication network having advantages not taught by the prior art.

In one aspect, the present invention provides a system for integrating a first application server container with a second application server container in a telecommunication network. The system comprising a bidirectional messaging bus having a first end and a second end, a first messaging adapter conforming to the first application server container, the first messaging adapter communicably connected to the first end of the messaging bus and is deployed in the first application server container and a second messaging adapter conforming to the second application server container, the second messaging adapter communicably connected to the second end of the messaging bus and is deployed in the second application server container.

In another aspect, the present invention provides a system where a replacement of any of the first and the second application server container with a third application server container needs only change in configuration of messaging adapter in the unchanged application server container to conform with the third application server container.

In yet another aspect, the present invention provides a system where the business logic program is executed on the first and the second application server containers, independent of the operation of the messaging bus communication.

In another aspect, the present invention provides a method for integrating a first application server container with a second application server container in a telecommunication network.

These together with other aspects of the invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the invention.

### BRIEF DESCRIPTION OF THE DRAWINGS

The advantages and features of the present invention will become better understood with reference to the following more detailed description taken in conjunction with the accompanying drawings in which:

FIG. 1 illustrates a schematic diagram for integrating two application server containers;

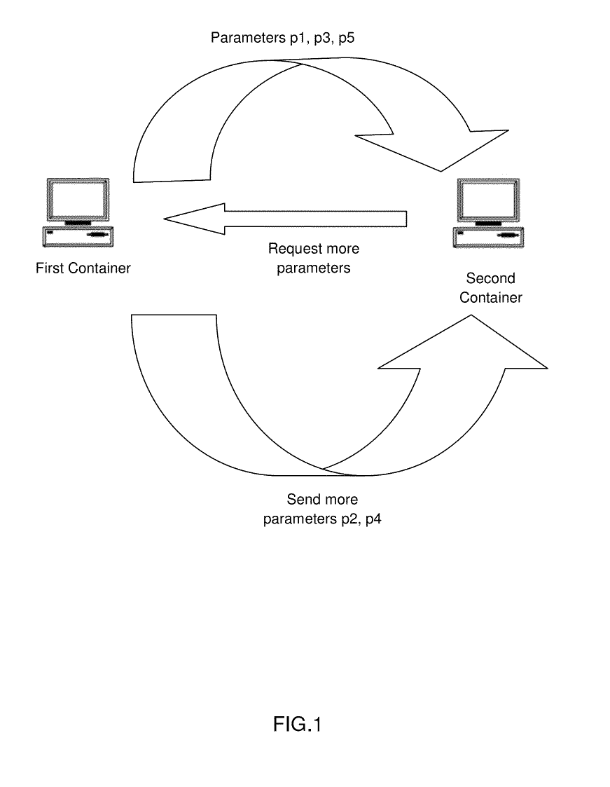

FIG. 2 illustrates a system for integrating a first application server container with a second application server container, according to one embodiment of the present invention;

FIG. 3 illustrates a system for integrating a first application server container with a second application server container, according to another embodiment of the present invention; and

FIG. 4 illustrates a flowchart of a method for integrating first application server container with a second application server container, according to one embodiment of the present invention.

Like reference numerals refer to like parts throughout the several views of the drawings.

### DETAILED DESCRIPTION OF THE DRAWINGS

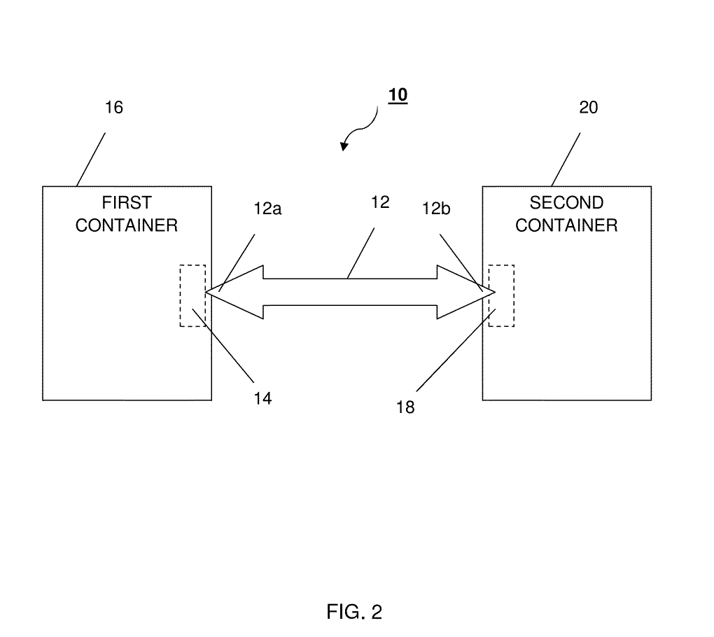

Referring to FIG. 2 which illustrates a system for integrating a first application server container with a second application server container, according to one embodiment of the present invention. The system 10 includes a bidirectional messaging bus 12 having a first end 12a and a second end 12b, a first messaging adapter 14 conforming to the first application server container 16 such that the first messaging adapter 14 is communicably connected to the first end 12a of the messaging bus and is deployed in the first application server container 16 and a second messaging adapter 18 conforming to the second application server container 20 such that the second messaging adapter 18 is communicably connected to the second end 12b of the messaging bus and is deployed in the second application server container 20.

The messaging bus 12 specializes in transporting messages between applications. A messaging bus contains three key elements namely: a set of agreed- upon message schemas, a set of common command messages, and a shared infrastructure for sending bus messages to recipients.

When the messaging bus 12 is used, an application that sends a message no longer has individual connections to all the applications that must receive the message. Instead, the application merely passes the message to the messaging bus 12, and the messaging bus 12 transports the message to all the other applications that are listening for bus messages through a shared infrastructure. Similarly, an application that receives a message no longer obtains it directly from the sender. Instead, it takes the message from the messaging bus 12.

In one embodiment of the present invention the messaging bus 12 is a stateless bus. The messaging bus 12 may be a generic messaging bus which can work independently and in other contexts as well.

Messaging adapters are the layer that has an API that is aligned with the container programming model where it resides. Messaging adapters connect to messaging bus over a generic messaging protocol. The messaging adapters work only with the messaging bus. In one embodiment of the present invention the first and the second messaging adapters 16 and 18 are stateful messaging adapters.

In one embodiment of the present invention, the first and the second messaging adapters 14 and 18 are programmable based on the requirements of the first and the second application server containers 16 and 20. The messaging adapter 14 and 18 can be programmed to conform to changes in the application server containers 16 and 20. For example say if the application on the second application server container 20 is updated, it will not be compatible with the information received from the first container 16 which is conforming with the old operating system. So, the configuration of the messaging adapter 18 needs to be changed so that the information sent from the first container 16 is understood by the second container 20.

As discussed earlier the ‘business logic’ of the containers 16 and 20 remains on their respective servers and the ‘integration logic’ only need to be changed for any change in the servers. The messaging adapter programming provides the facility to make changes in the second container 20 without having to make changes in the first container 16.

Similarly in another embodiment of the present invention a replacement of any of the first or the second application server container 16 and 20 with a third application server container needs only change in configuration of respective messaging adapter to conform with the third application server container. Say for example if the container 16 is replaced by another container ‘C’ then no changes may be required to be done on the second container 20 and only the changes may have to be done in the configuration of the second messaging adapter 18. The changes are made in the ‘integration logic’ of the messaging adapter 18 to make the container ‘C’ and second container 20 work as expected. Additionally another messaging adapter ‘A’ needs to be implemented in container ‘C’ as per the programming model of container ‘C’. The ‘business logic’ program is executed on the first and the second application server containers 16 and 20, such that the business logic program is executed independent of the operation of the messaging bus 12 communication. In one embodiment of the present invention the first and the second messaging adapters 14 and 18 are stateful messaging adapters.

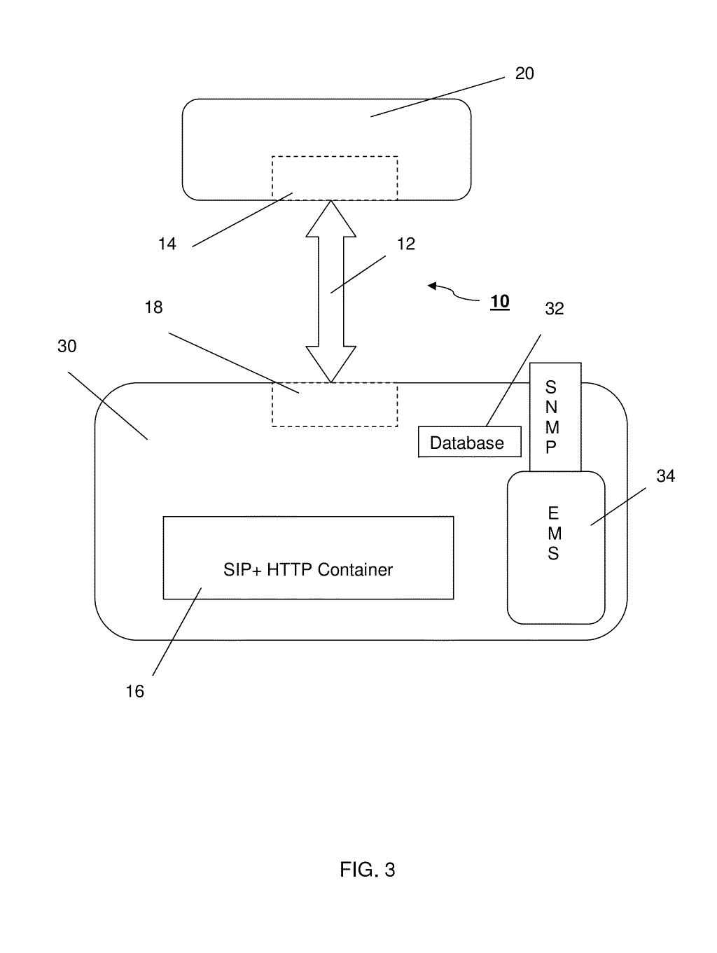

Referring to FIG. 3 which illustrates the system 10 for integrating a first application server container with a second application server container, according to another embodiment of the present invention. The first application server container 16 is a SIP+HTTP container and the second application server container 20 is a JEE container. The SIP+HTTP container 16 resides on a telephony application server 30 which includes a database 32, an EMS(Element management system) 34 which uses Simple Network Management Protocol (SNMP) protocol, etc. The SIP+HTTP container 14 is integrated with external JEE container 18 using the system 10 by externalizing the complex business logic in the form of JEE business objects but maintain a simple messaging protocol between the SIP+HTTP container 14 and the JEE container 18. The messaging between the two containers allows to scale the integration to two or more containers separately and to manage these independently. Since this approach does not require combining or merging different programming models but keeps these separate running in separate containers yet provides the same functionality from application perspective, this is much cleaner and scalable solution.

The key to make this invention work and what makes it unique is the state management across the two messaging adapters and the messaging between them. This enables a seamless invocation of business logic across the containers such that it is transparent to these that the business logic is actually invoked remotely. This is different from various remote method invocation mechanisms in that the session states are maintained by messaging adapters and that it is a fault resilient mechanism.

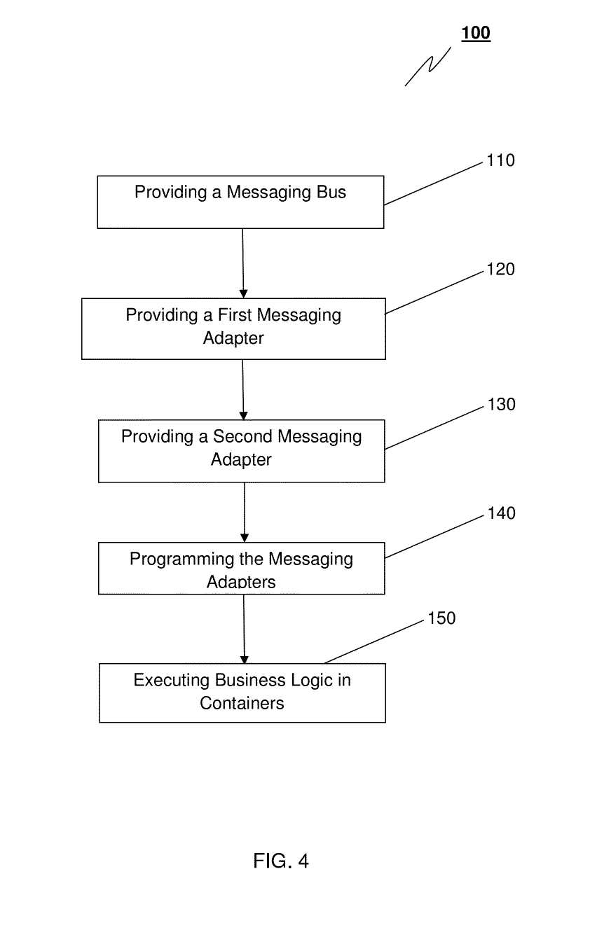

Referring to FIG. 4 which illustrates a flowchart of a method 100 for integrating first application server container 14 with a second application server container 20, according to one embodiment of the present invention. The method 100 starts with step 110 of providing the bidirectional messaging bus 12 having a first end 12a and the second end 12b. The messaging bus 12 is a bidirectional bus.

In next step 120 the first messaging adapter 14 conforming to the first application server container 16 is provided. The first messaging adapter 14 is communicably connected to the first end 12a of the messaging bus 12 and is deployed in the first application server container 16.

Next the second messaging adapter 18 conforming to the second application server container 20 is provided in step 130. The second messaging adapter 18 is communicably connected to the second end 12b of the messaging bus 12 and is deployed in the second application server container 20. The properties of the messaging bus 12 and the messaging adapters 14 and 18 are same as discussed in the earlier part of the description.

The method 100 further includes programming the first and the second messaging adapters 14 and 18 based on the requirements of the first and the second application server containers 16 and 20, to conform with any changes done to the respective containers in step 140.

The method 100 further includes step 150 in which the business logic program is executed on at least one of the first and the second application server containers 16 and 20 and runs independent of the operation of the messaging bus 12 communication.

The system 10 and method 100 have been made for complex telecom deployment for integrating SIP+HTTP container with external JEE container. However this approach can be used to integrate multiple application containers running separate programming models for other domains too. This is not limited to a specific implementation language too, and in fact can be used to interwork between application containers implemented in different languages, provided that a message bus exists or can be constructed to establish communication between containers.

The preliminary problem for this approach was worked out involved JVM based application containers. JMS (Java Messaging Service) was used as the messaging protocol. In order to implement this invention, different Java based containers may be required. These could be standard Java based HTTP or JEE containers which can be open sourced or commercially available. In order for the application on one container to invoke external business logic, or for multi-protocol application, these multiple containers will be connected together using the messaging bus and stateful messaging adapters. The latter will require coding in such a way that request/response state will be maintained at messaging adapters when a message is sent on the messaging bus. In this way applications hosted on individual containers will not see the difference between local or remote business logic.

In some embodiment the messaging bus 12 may be replaced by a different transport like stateful web services interface, and the messaging adapters 14 and 18 have to be modified to suit the transport in these cases.

Although a particular exemplary embodiment of the invention has been disclosed in detail for illustrative purposes, it will be recognized to those skilled in the art that variations or modifications of the disclosed invention, including the rearrangement in the steps of the method, changes in sequence, variations in steps may be possible. Accordingly, the invention is intended to embrace all such alternatives, modifications and variations as may fall within the spirit and scope of the claims of the present invention.

The exemplary embodiments described herein detail for illustrative purposes are subject to many variations of structure and design. It should be emphasized, however that the present invention is not limited to particular system and method for integrating application server containers in a telecommunication network, as shown and described. Rather, the principles of the present invention can be used with a variety of configurations and arrangements of system and method for integrating application server containers in a telecommunication network. It is understood that various omissions, substitutions of equivalents are contemplated as circumstances may suggest or render expedient, but the present invention is intended to cover the application or implementation without departing from the spirit or scope of the claims.

As used in this application, the words “a,” “an,” and “one” are defined to include one or more of the referenced item unless specifically stated otherwise. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

What is claimed is:

1. A system for integrating a first application server container with a second application server container in a telecommunication network, comprising;
a bidirectional messaging bus having a first end and a second end;
a first messaging adapter conforming to the first application server container, the first messaging adapter communicably connected to the first end of the messaging bus and is deployed in the first application server container; and
a second messaging adapter conforming to the second application server container, the second messaging adapter communicably connected to the second end of the messaging bus and is deployed in the second application server container.

2. The system according to claim 1, wherein the first and the second messaging adapters are programmable based on the requirements of the first and the second application server containers.

3. The system according to claim 1, wherein a replacement of any of the first and the second application server container with a third application server container needs only change in configuration of respective messaging adapter to conform with the third application server container.

4. The system according to claim 1, wherein the first application server container is a SIP+HTTP container.

5. The system according to claim 4, wherein the second application server container is a JEE container.

6. The system according to claim 1, wherein a business logic program is executed on the first and the second application server containers, such that the business logic program is executed independent of the operation of the messaging bus communication.

7. The system according to claim 1, wherein the messaging bus is a stateless bus.

8. The system according to claim 1, wherein the first and the second messaging adapters are stateful messaging adapters.

9. A method of integrating a first application server container and a second application server container in a telecommunication network, comprising the steps of:
providing a bidirectional messaging bus having a first end and a second end;
providing a first messaging adapter conforming to the first application server container, the first messaging adapter communicably connected to the first end of the messaging bus and is deployed in the first application server container; and
providing a second messaging adapter conforming to the second application server container, the second messaging adapter communicably connected to the second end of the messaging bus and is deployed in the second application server container.

10. The method according to claim 9, further comprising executing a business logic program on the first and the second application server containers, independent of the operation of the messaging bus communication.

11. The method according to claim 9, further comprising programming the first and the second messaging adapters based on the requirements of the first and the second application server containers.
